(19) United States
(12) Patent Application Publication
(10) Pub. No.: US 2026/0077730 A1
(43) Pub. Date: Mar. 19, 2026

(54) CENTRAL VEHICLE CONTROL UNIT FOR A TRAILER UNIT

(71) Applicant: Great Dane LLC, Savannah, GA (US)

(72) Inventors: Christian Sungho LEE, W. Pooler, GA (US); Colby Lee WHITE, Savannah, GA (US); Pavithra GANESAN, Savannah, GA (US)

(21) Appl. No.: 19/331,602

(22) Filed: Sep. 17, 2025

Related U.S. Application Data
(60) Provisional application No. 63/695,617, filed on Sep. 17, 2024.

(51) Int. Cl. B60R 16/033; B60H 1/00; B60L 7/10; B60P 3/20; B60R 16/023; B60T 7/20; B62D 59/04; F25D 11/00; G07C 5/08; H02J 7/00

(52) U.S. Cl. CPC B60R 16/033; B60H 1/00364; B60H 1/00428; B60H 1/00978; B60L 7/10; B60P 3/20; B60R 16/0238; B60T 7/20; F25D 11/003; G07C 5/0808; H02J 7/50; B60L 2200/28; B62D 59/04

(57) ABSTRACT

A trailer unit having a plurality of trailer subsystems and a main vehicle control unit. The plurality of trailer subsystems can include an energy storage subsystem having one or more battery packs and a first primary switch, a power distribution subsystem for distributing power from the energy storage subsystem to one or more of the plurality of trailer subsystems having a second primary switch, a thermal management subsystem for controlling a temperature of at least a portion of the energy storage subsystem, an inverter subsystem for inverting the power from the energy storage subsystem, and a converter subsystem for converting the power from the energy storage subsystem. The main vehicle control unit can be coupled to each of the plurality of trailer subsystems for communicating with and for controlling each of the plurality of trailer subsystems.

### RELATED APPLICATION

The present application claims priority to U.S. provisional patent application Ser. No. 63/695,617, filed on Sep. 17, 2024, and entitled Central Vehicle Control Unit For A Trailer Unit, the contents of which are herein incorporated by reference.

### BACKGROUND OF THE INVENTION

The present invention relates to trailer units used in logistics and transport industries, and more particularly relates to trailer units equipped with advanced communication and control subsystems for improved operational efficiency.

In the transport sector, it is increasingly important to ensure that trailer units operate with maximum efficiency, provide real-time data to fleet operators, and comply with environmental regulations. This necessitates the integration of various components, subsystems, and communication technologies within the trailer unit, that employ a trailer central gateway (TCG). The TCG is usually one of the communication hubs employed in the trailer unit and is responsible for managing communications between various subsystems within the trailer units, as well as transmitting data to remote fleet management and operational centers. The TCG is typically equipped with wireless communication technology, such as high speed wireless (e.g., LTE or 5G) or satellite communication, allowing for real-time data exchange and communication with remote systems. The TCG thus typically and conventionally functions as a primary communication manager for the trailer unit.

Conventional trailer units can include various systems and subsystems for controlling different aspects of the trailer units. For example, the trailer unit can include a series of controllable axles, which can include an electronic axle (e-axle) for providing propulsion to the trailer unit. The axles can have one or more braking systems, such as an electronic braking system (EBS) associated therewith for providing braking or stopping power to the trailer unit. The braking systems can also have associated therewith advanced braking technologies, such as anti-lock braking systems (ABS). The TCG can collect data on brake usage, wear, and health, and communicate the data to fleet operations so as to better monitor and predict maintenance needs. The braking system can also include diagnostic features that can communicate error codes or faults to remote management systems for immediate attention.

In refrigerated trailer units, the trailer unit can include a refrigeration system that is configured to maintain cargo temperature within specific limits. The refrigeration system can include compressors, evaporators, condensers, and control electronics. The TCG can interface with the refrigeration system to gather data and to monitor the temperature, power consumption, and operational status. The system also includes sensors that provide real-time data on the internal environment, which can be transmitted to fleet operators. In some cases, remote commands can be issued to adjust the temperature setpoints or initiate defrost cycles.

In trailer units that are part of multi-trailer configurations, a dolly unit can be employed to connect the trailers and includes additional axles. The dolly unit may also be equipped with electronic sensors for monitoring tire pressure, axle alignment, and other operational metrics. The TCG communicates with the dolly unit to ensure the smooth operation of multiple trailers, optimizing the performance and safety of the entire trailer configuration.

The trailer's telematics system can also communicate with the TCG, which aggregates selected types of data, such as vehicle speed, location, cargo weight, fuel usage, and driver, so as to enable fleet operators to optimize routes, monitor driver performance, and manage compliance with regulatory requirements. Data collected through the telematics system can also be used to improve maintenance scheduling as the TCG monitors the health of critical trailer components and alerts fleet operators when preventive maintenance is required.

This integrated system of components and subsystems allows modern trailer units to function more efficiently, safely, and reliably, while providing real-time data to fleet operators for enhanced operational control. By centralizing communication within the TCG, fleet operators are able to manage a wide range of functions remotely, leading to reduced operational costs, improved fleet utilization, and enhanced safety compliance. A drawback of conventional trailer units are that the various subsystems require specialized and custom interfaces to properly interface with the trailer central gateway. Moreover, the information generated by one or more of the subsystems may not be utilized by other systems of the trailer unit because of the lack of uniformity of communication and the lack of proper interfaces with the trailer central gateway. Further, the TCG primarily functions as a communication hub, and is generally limited to the aggregation and transmission of signals rather than performing higher-level data processing.

### SUMMARY OF THE INVENTION

The trailer unit of the present invention employs a central or main trailer controller that performs the functions of a trailer central gateway while concomitantly centralizing the data processing and control therein. The main trailer controller of the present invention can function as a vehicle control unit that can be a high-power compute module (HPCM) that serves as the central and main processor of the software enabled electrified smart trailer unit, responsible for controlling and managing various aspects of the performance, functionality, and safety of the trailer unit and associated subsystems.

The present invention is directed to a trailer unit for transporting cargo. The system can include a plurality of trailer subsystems and a main vehicle control unit. The plurality of trailer subsystems can include an energy storage subsystem having one or more battery packs for storing power therein and a first primary switch for forming a battery power path, where the energy storage subsystem generates battery related data; a power distribution subsystem for distributing power from the energy storage subsystem to one or more of the plurality of trailer subsystems having a second primary switch for forming a power distribution power path and a secondary switch for forming a secondary power path, where the power distribution subsystem generates power related data; a thermal management subsystem that is configured to control a temperature of at least a portion of the energy storage subsystem, where the thermal management subsystem generates thermal related data; an inverter subsystem for inverting the power from the energy storage subsystem for use by one or more of the plurality of trailer subsystems; and a converter subsystem for converting the power from the energy storage subsystem from a first power level to a second different power level suitable for use by one or more of the plurality of trailer subsystems. The main vehicle control unit can be coupled to each of the plurality of trailer subsystems for communicating with and for controlling each of the plurality of trailer subsystems. The main vehicle control unit can be configured to receive and to process the battery related data to control the first primary switch, the power related data to control the second primary switch and the secondary switch, and the thermal related data to control the temperature of the portion of the energy storage subsystem.

The thermal management subsystem can be configured to regulate a temperature of the one or more battery packs of the energy storage subsystem and/or to regulate a temperature of one or more of the plurality of trailer subsystems in addition to the energy storage subsystem. The main vehicle control unit, based on the thermal related data, can be configured to switch the thermal management subsystem into one of a plurality of operating modes, and can be configured to monitor and to control an operating state of the inverter subsystem and the converter subsystem.

The plurality of trailer subsystems can further include a service tool subsystem that is configured to provide diagnostic, configuration, and testing capabilities for the trailer unit. The service tool subsystem can generate diagnostic related data, configuration data and/or testing data for processing by the vehicle control unit. The plurality of trailer subsystems can also include a braking subsystem for providing braking functionality, where the braking subsystem generates braking related data. The vehicle control unit receives and processes the braking related data and generates braking control signals for controlling the braking subsystem. Still further, the plurality of trailer subsystems includes an electronic axle subsystem configured to generate regenerative power during trailer operation and to provide the regenerative power to at least the energy storage subsystem, and a refrigeration subsystem that is configured to control a temperature of the cargo space by receiving power from at least one of the energy storage subsystem and the power distribution subsystem. The main vehicle control unit can be configured to control the power supplied to the refrigeration subsystem.

According to one embodiment, the main vehicle control unit can be configured to generate and to transmit a first control signal to the energy storage subsystem to close the first primary switch to allow the power to flow from the one or more battery packs along the battery power path to one or more of the plurality of trailer subsystems. The main vehicle control unit can also be configured to generate and to transmit a second control signal to the power distribution subsystem to close the second primary switch to form the power distribution power path to allow the power from the one or more battery packs of the energy storage subsystem to flow to the inverter subsystem and to the converter subsystem. The main vehicle control unit can then generate and transmit a third control signal to the power distribution subsystem to close the secondary switch to form the secondary power path to provide power from the one or more battery packs to the refrigeration subsystem.

The main vehicle control unit can be configured to generate an inverter control signal to activate the inverter subsystem. The one or more battery packs can produce direct current (DC) power that passes along the power distribution power path to the inverter subsystem, and the inverter subsystem converts the DC power to alternating current (AC) power. The AC power then passes along the secondary power path to the refrigeration subsystem. The DC power from the battery packs can be at a first DC power level, and the main vehicle control unit can be configured to generate a converter control signal to activate the converter subsystem, which steps down the DC power from the first DC power level to a second lower DC power level. The main vehicle control unit can be configured to monitor one or more of the plurality of trailer subsystems for a selected power fault, and if detected, initiate a power corrective action. The electronic axle subsystem can be configured to generate the regenerative power and the main vehicle control unit can be configured to communicate with the electronic axle subsystem. The main vehicle control unit can detect that the electronic axle subsystem is generating regenerative power, which is then conveyed to the refrigeration subsystem via at least the power distribution power path.

The present invention is also directed to a method for controlling a plurality of trailer subsystems in a trailer unit having a cargo space. The plurality of trailer subsystems can include an energy storage subsystem having one or more battery packs for storing power therein and a first primary switch for forming a battery power path, where the energy storage subsystem generates battery related data; a power distribution subsystem for distributing power from the energy storage subsystem to one or more of the plurality of trailer subsystems, where the power distribution subsystem has a second primary switch for forming a power distribution power path and a secondary switch for forming a secondary power path, where the power distribution subsystem generates power related data; a thermal management subsystem that is configured to control a temperature of at least a portion of the energy storage subsystem, where the thermal management subsystem generates thermal related data; an inverter subsystem for inverting the power from the energy storage subsystem for use by one or more of the plurality of trailer subsystems; a converter subsystem for converting the power from the energy storage subsystem from a first power level to a second different power level suitable for use by one or more of the plurality of trailer subsystems; an electronic axle subsystem configured to generate regenerative power during trailer operation and to provide the regenerative power to at least the energy storage subsystem; and a refrigeration subsystem that is configured to control a temperature of the cargo space by receiving power from at least one of the energy storage subsystem and the power distribution subsystem. The trailer unit can also include a main vehicle control unit that is coupled to each of the plurality of trailer subsystems for communicating with and for controlling each of the plurality of trailer subsystems. The main vehicle control unit can be configured to receive and to process the battery related data to control the first primary switch, the power related data to control the second primary switch and the secondary switch, and the thermal related data to control the temperature of the portion of the energy storage subsystem. The method can include generating, with the main vehicle control unit, a first control signal and transmitting the first control signal to the energy storage subsystem to close the first primary switch to allow the power to flow from the one or more battery packs along the battery power path; generating, with the main vehicle control unit, a second control signal and transmitting the second control signal to the power distribution subsystem to close the second primary switch to form the power distribution power path to allow the power from the one or more battery packs of the energy storage subsystem to flow to the inverter subsystem and to the converter subsystem; and generating, with the main vehicle control unit, a third control signal and transmitting the third control signal to the power distribution subsystem to close the secondary switch to form the secondary power path to provide power from the one or more battery packs to the refrigeration subsystem.

The method of the present invention can also include generating, with the main vehicle control unit, an inverter control signal to activate the inverter subsystem, where the one or more battery packs produces direct current (DC) power that passes along the power distribution power path to the inverter subsystem, and converting, with the inverter subsystem, the DC power to alternating current (AC) power. The AC power passes along the secondary power path to the refrigeration subsystem. Further, the DC power from the one or more battery packs is at a first DC power level, and the method includes generating, with the main vehicle control unit, a converter control signal to activate the converter subsystem for stepping down the DC power from the first DC power level to a second lower DC power level. The method also includes monitoring, with the main vehicle control unit, one or more of the plurality of trailer subsystems for a selected power fault, and if detected, initiating a power corrective action. The method further comprises generating the regenerative power with the electronic axle subsystem, and if the regenerative power is detected by the main vehicle control unit, conveying the regenerative power to the refrigeration subsystem via at least the power distribution power path.

### BRIEF DESCRIPTION OF THE DRAWINGS

These and other features and advantages of the present invention will be more fully understood by reference to the following detailed description in conjunction with the attached drawings in which like reference numerals refer to like elements through the different views. The drawings illustrate principals of the invention and, although not to scale, show relative dimensions.

FIG. 1 is a schematic block diagram of a trailer system showing the various associated subsystems and a main trailer controller according to the teachings of the present invention.

FIG. 2 is a schematic block diagram of the trailer system of FIG. 1 showing additional various subsystems according to the teachings of the present invention.

FIG. 3 is a schematic block diagram of a methodology for sharing and distributing power from the energy storage subsystem to selected subsystems of the trailer unit according to the teachings of the present invention.

FIG. 4 is a schematic block diagram of a methodology for controlling and managing shore power with the vehicle control unit according to the teachings of the present invention.

FIG. 5 is a schematic block diagram of a methodology for harnessing and controlling with the vehicle control unit the power generated by an electric axle subsystem according to the teachings of the present invention.

### DETAILED DESCRIPTION OF THE INVENTION

As used herein, terms referring to a direction or a position relative to the orientation of the trailer, such as but not limited to “vertical,” “horizontal,” “top,” “bottom,” “upper,” “lower,” “above,” “below,” “front” or “back” refer to directions and relative positions with respect to the structure and orientation of the flatbed trailer in its normal intended operational positions and use. Thus, for instance, the terms “vertical” and “upper” and “top” refer to the vertical orientation and relative upper/top positions and should be understood in that context, even with respect to a trailer that may be disposed in a different orientation. The term “parallel” encompasses offset from and parallel to, as well as coincident with.

Further, the term “or” as used in this application and the appended claims is intended to mean an inclusive “or” rather than exclusive “or.” That is, unless specified otherwise, or clear from the context, the phrase “X employs A or B” is intended to mean any of the naturally inclusive permutations. That is, the phrase “X employs A or B” is satisfied by any of the following instances: X employs A; X employs B; or X employs both A and B. In addition, the articles “a” and “and” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “and,” and “b” may include plural references, and the meaning of “in” may include “in” and “on.” The phrase “in one embodiment,” as used herein, does not necessarily refer to the same embodiment, although it may.

As used herein, a “vehicle control unit” or “main trailer controller” refers to an electronic control system functioning as a main controller that can be responsible for managing, coordinating, monitoring, or communicating with the operation of various sensors, systems, and subsystems within a trailer unit, such as for example the braking system, axle systems (including e-axles), refrigeration units, power management systems, thermal management systems, tire pressure monitoring systems, telematics devices, and the like. The vehicle control unit can serve as a central communication and processing hub for the trailer unit, facilitating data exchange, control, management, and data processing, between the internal and external systems of the trailer unit, such as with remote fleet management or operations platforms. The vehicle control unit can be configured to collect operational data from sensors and subsystems distributed across the trailer unit and process the data to ensure optimal performance, safety, and regulatory compliance. The vehicle control unit can also receive commands from external systems via wireless communication technologies (e.g., LTE, WiFi, 5G, satellite, and the like) to enable remote diagnostics, control adjustments, and software updates. The functions of the vehicle control unit can include, but are not limited to, monitoring trailer health, managing energy distribution, controlling braking and propulsion systems, optimizing refrigeration operation, and other data processing and communication operations.

The trailer unit of the present invention, and as described herein, can be a non-motorized vehicle designed to be towed by a powered vehicle, such as a truck (e.g., tractor), for the purpose of transporting goods or cargo. The trailer unit can be equipped with various mechanical, electrical, and electronic subsystems that enable safe, efficient, and environmentally compliant operation. Depending on the configuration and intended use, the trailer unit can include, for example, any combination of a chassis, an axle subsystem (e.g., an e-axle), a suspension subsystem, a dolly subsystem, a braking subsystem, an object detection subsystem, a safety subsystem, a braking subsystem, a refrigeration subsystem, a lighting and signaling subsystem, a tire pressure monitoring subsystem, a power supply subsystem, an electrical subsystem, a telematics subsystem, a communication subsystem, a security subsystem, a cargo or payload area, and the like. Other systems and subsystems can also be employed in the trailer unit and are contemplated by the present invention. In the context of the trailer unit, the term “cargo” can refer to goods, materials, or products that are placed within a cargo area of the trailer unit for the purpose of transportation from one location to another. The cargo can include perishable goods, such as food items or pharmaceuticals, that require controlled temperature conditions, as well as non-perishable goods, such as consumer products, industrial equipment, or raw materials. The cargo may be packaged in boxes, crates, pallets, containers, or other forms suitable for storage and transport within the trailer. In certain embodiments, the cargo may require environmental regulation, including temperature, humidity, or airflow control, which is facilitated by subsystems such as the refrigeration subsystem and the thermal management subsystem of the trailer unit 12. As such, the cargo can encompass any type of load that can be carried within the trailer for delivery, regardless of its physical form, packaging, or environmental requirements.

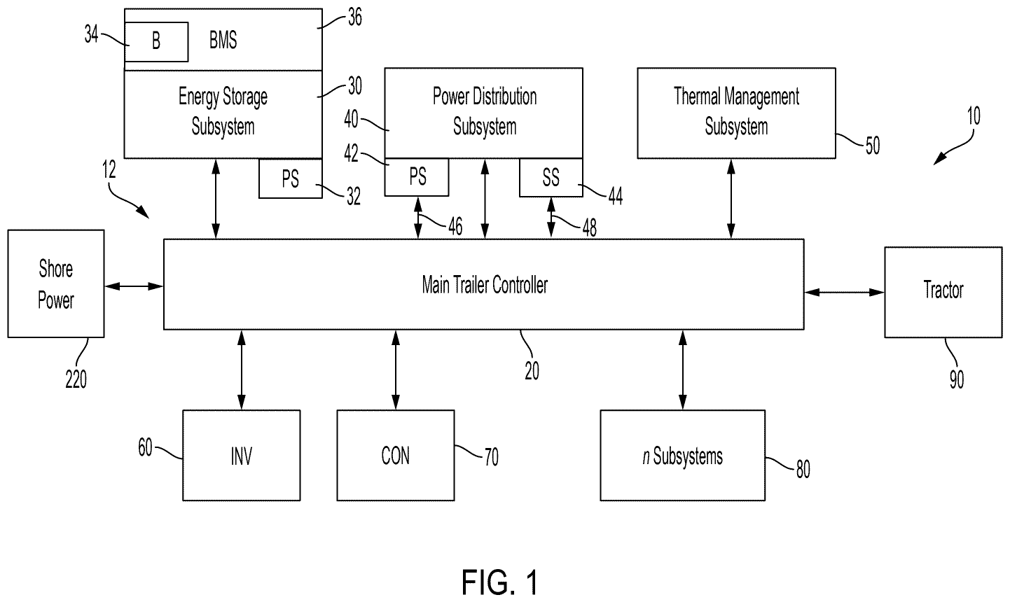

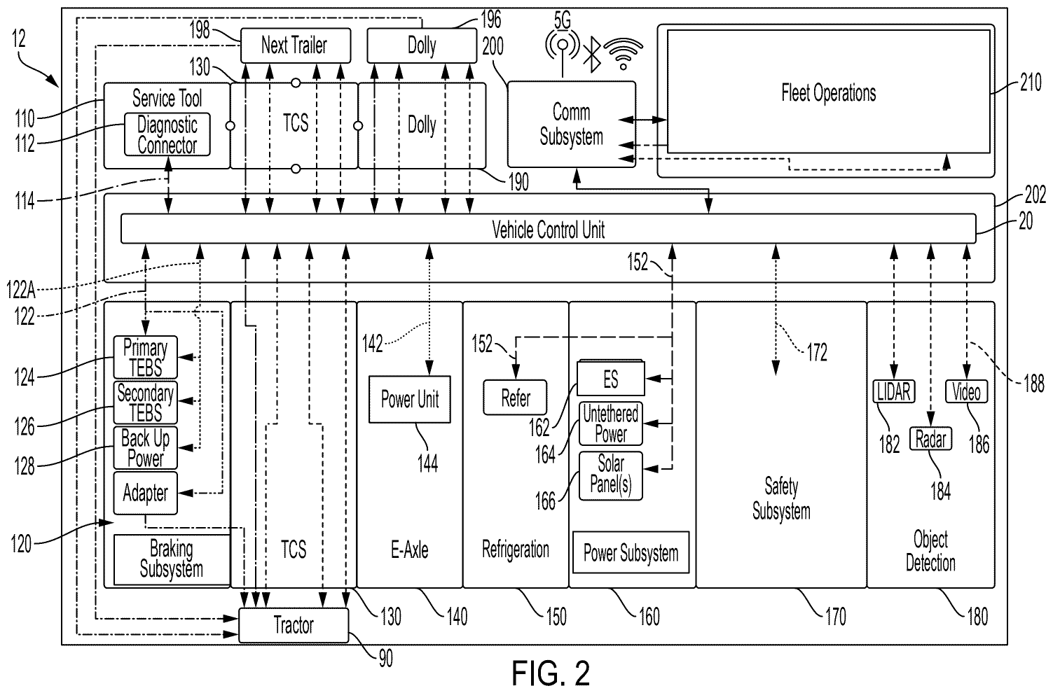

A schematic representation of a trailer system according to the teachings of the present invention is shown, for example, in FIGS. 1 and 2. The illustrated trailer system 10 includes a trailer unit 12 that can be coupled to a tractor 90. The tractor 90 can be any suitable type of towing vehicle, such as a truck, or another trailer unit or dolly subsystem. The illustrated trailer unit 12 can include a central or main trailer controller 20, referred to herein as a main vehicle control unit 20. The main vehicle control unit 20 can function and operate as the central control, communication, and processing entity of the trailer unit 12. The vehicle control unit 20 can function to manage, control, and monitor various subsystems associated with the trailer unit 12. According to one example embodiment, the trailer unit 12 can include an energy management subsystem 30, a power distribution subsystem 40, a thermal management subsystem 50, an inverter 60, a converter 70, and various additional subsystems 80, as shown in FIG. 2. The illustrated subsystems can be coupled to the vehicle control unit 20 by suitable communication links, such as for example by controller area network (CAN) buses that provide communication between the vehicle control unit 20 and the associated trailer subsystems. In certain embodiments, the vehicle control unit 20 can be configured to interface and communicate with the trailer subsystems through the CAN buses. For example, the vehicle control unit 20 can transmit control commands and receive operational data or diagnostic information from the subsystems over the buses. The communication between the vehicle control unit 20 and the subsystems can be implemented using standardized or proprietary message protocols defined for the CAN buses (e.g., ISO 11992 or J1939), thereby providing a structured communication interface that enables coordinated operation and monitoring of the trailer subsystems. The use of the CAN buses within the trailer unit 12 enables real-time, fault-tolerant communication between the vehicle control unit 20 and the associated subsystems and supports safe and efficient operation of the trailer unit. The communication protocols and communication pathways between the vehicle control unit 20 and the various trailer subsystems are known and need not be described further herein. Further, the various trailer subsystems can include their own electronic control unit (ECU) that communicates with the main vehicle control unit 20, and the vehicle control unit 20 can control and manage the various ECUs of the subsystems.

The illustrated trailer unit 12 can include various subsystems and components that are controlled and managed by the vehicle control unit 20. For example, the energy storage and management subsystem 30 can be configured to provide electrical power for operation of one or more of the subsystems of the trailer unit. The energy storage subsystem 30 can include a battery management subsystem 36 operative to monitor, control, and protect one or more rechargeable battery packs 34. The battery management subsystem 36 can include sensing circuitry for measuring cell voltages, pack current, and temperature, as well as control circuitry for balancing cells, managing charge and discharge cycles, and implementing protective functions such as over-voltage, under-voltage, over-current, and thermal protection. The battery management subsystem 36 can further optionally include a communication interface configured to exchange energy or battery related data, such as state-of-charge of the battery pack, state-of-health of the batter pack, diagnostic information related to the battery pack, switch status and related information, and the like, with the vehicle control unit 20. The vehicle control unit 20 can thus process the battery related data received from the energy storage subsystem 30 in a centralized location so as to be able to properly monitor and control the energy storage subsystem 30 and can provide control signals to the subsystem to respond in real time to the information. For example, the vehicle control unit 20 can monitor the voltage state of the energy storage subsystem 30, including high voltage conditions and states and monitor pre-charge status and statistics of the battery packs 34 (e.g., state of charge, fault condition, and the like). The vehicle control unit 20 can also control the contact positions (e.g., ON/OFF) of any selected contacts or switches, such as the primary power switch 32.

The trailer unit 12 further includes a power distribution subsystem 40 configured to distribute electrical power from the energy storage subsystem 30 to a plurality of trailer loads (e.g., trailer subsystems). In the context of the trailer unit 12, the power distribution subsystem 40 functions as the intermediary between the energy management subsystem 30 and the various trailer subsystems or loads. The power distribution subsystem 40 can function to route, regulate, and protect the flow of electrical energy or power while communicating with the vehicle control unit (VCU) for coordination and optimization. The power distribution subsystem 40 can include one or more of, or any combination of, current and voltage sensors, fuses, relay modules or switches (e.g., contactors), thermal monitoring components, converters, and diagnostic electronics or controllers for supervising local subsystem operation and providing communication with the vehicle control unit. According to one embodiment, the power distribution subsystem 40 can include a primary switch 42 that forms a primary power path 46 and a secondary switch 44 that forms a secondary power path 48. The power distribution subsystem 40 can be controlled to selectively connect and disconnect the trailer loads in response to control signals from the vehicle control unit 20.

The power distribution subsystem 40 can be further configured to monitor load currents and voltages, detect faults, and implement protective isolation functions in the event of a power failure condition. The power related data generated and collected by the power distribution subsystem 40 can be communicated to the vehicle control unit 20 to be processed thereby and to facilitate coordinated load management across the trailer unit 12 and to control and manage the power distribution across the trailer unit 12. The power related data can include, for example, switch status data, such as the open or closed state of the primary and secondary switches 42, 44, voltage and current measurements, and load-specific power consumption data for subsystems such as a refrigeration subsystem 150, an electronic axle subsystem 140, a safety subsystem 170, and the like. The power related data can also include fault data, including indications of overvoltage, undervoltage, overcurrent, short-circuit, or isolation faults, as well as status data regarding fuses or circuit breakers. Additional power related data can include thermal measurements from components and connectors, operational statistics such as event logs, efficiency data, or switching history, and predictive maintenance indicators based on contactor cycling or thermal stress. The vehicle control unit 20 can receive and process the power related data to monitor trailer operation, optimize power distribution, implement fault protection strategies, and support maintenance planning.

The trailer unit 12 can also include a thermal management subsystem 50 that can be configured to manage or regulate the temperature of at least a portion of the energy storage system 30 and one or more additional trailer subsystems or components thereof. The thermal management subsystem 50 can include, for example, one or more of, or any combination of, heat exchangers, liquid coolant circuits, pumps, fans, power electronics, and valves configured to remove heat from the battery packs 34 of the battery management subsystem 36 or other heat-generating subsystems. The thermal management subsystem 50 can further optionally include sensors for measuring coolant temperature, flow rate, and system pressure. The thermal management subsystem can generate a variety of thermal related data that is communicated to and processed by the vehicle control unit 20 to ensure safe and efficient operation. The thermal related data can include, for example, real-time temperature measurements from thermal sensors associated with the battery packs 34, at coolant inlets and outlets, or at selected electronic components. Additional thermal related data can optionally include coolant flow rate data, coolant pump speed data, valve position data, or radiator or heat exchanger performance data, including inlet and outlet temperatures and fan speed. The thermal related data can also optionally include status and fault codes relating to coolant leaks, pump or fan failures, insufficient cooling or heating performance, or sensor malfunctions. Further, the thermal management subsystems can generate and transmit thermal related data that includes calculated or derived values, such as estimated thermal load, thermal efficiency, and projected cooling or heating demand based on system operating conditions. The vehicle control unit 20 can process the thermal related data to maintain operating temperatures within defined limits, optimize energy usage for heating or cooling, and initiate protective measures in the event of abnormal thermal conditions. Further, the vehicle control unit 20 can process the thermal related data to control the thermal management subsystem 50 to maintain the other associated trailer subsystems and components within desired operating temperature ranges, thereby optimizing performance and prolonging component life of the trailer unit 12. According to one example, the vehicle control unit 20 can monitor the operating state or mode of the thermal management subsystem 50. The operating modes can include, for example, a shutdown mode, a refrigeration mode, a heating mode, a self-circulation mode, and the like. The vehicle control unit 20 can control the thermal management subsystem 50 to switch the subassembly into one of the operating modes or between the modes. The vehicle control unit 20 can also set selected temperature thresholds or target ranges for the thermal management subsystem 50.

The trailer unit 12 can further include selected power conversion subsystems, such as an inverter subsystem 60 and a converter subsystem 70 (e.g., a DC-DC converter). The inverter subsystem 60 can be configured to invert the power (e.g., DC power) from the battery packs 34 of the battery management subsystem 36 into AC power suitable for use by one or more of the other trailer subsystems. The converter subsystem 70 can be configured to convert power from the battery packs 34 from a first higher power or voltage level to a lower power or voltage level that can be used to supply power to other subsystems and components.

The vehicle control unit 20 can be configured to monitor the operating state of the inverter subsystem 60, such as an idle state, a sleep state, a wake-up state, a charging state, an exporting state, a motor operation state, a balancing state, and the like. The vehicle control unit 20 can also control the inverter subsystem 60 to switch the inverter into one of the operating states or between the operating states, can set inverter battery voltage limits, as well as the frequency and voltage of the inverter output. Each of the inverter subsystem 60 and the converter subsystem 70 can include associated control circuitry, switching devices, inductors, capacitors, and thermal management features to ensure efficient and reliable power conversion. The vehicle control unit 20 can be communicatively coupled to inverter subsystem 60 and the converter subsystem 70 and can be configured to manage their operation in accordance with overall trailer power demands, energy efficiency objectives, and safety considerations. The vehicle control unit 20 can also be coupled to additional trailer subsystems 80 to provide data processing capabilities as well as to control, monitor and manage the subsystems.

The vehicle control unit 20 can thus serve as a centralized and main trailer controller operative to coordinate the functions of the energy management subsystem 30, the power distribution subsystem 40, the thermal management subsystem 50, the inverter subsystem 60, and the converter subsystem 70. In certain implementations, the vehicle control unit 20 can execute data processing techniques to centrally process data received from the subsystems and components and to monitor subsystem status, detect and respond to fault conditions, manage energy usage and thermal loads, and optimize overall trailer operation. The vehicle control unit 20 can further be configured to interface with a tractor unit 90 to receive high-level commands and provide subsystem status, thereby enabling integrated and safe operation of the trailer system 10.

The additional trailer subsystems 80 that can be coupled to the vehicle control unit 20 are shown in greater detail in FIG. 2. The vehicle control unit 20 can be configured to read and retrieve fault codes, access historical event logs, monitor real-time sensor data, and perform analysis of operational data from various subsystems, such as a service tool subsystem 110, a brake subsystem such as an electronic braking subsystem 120, a trailer connection subsystem 130, an electronic axle subsystem 140, a refrigeration subsystem 150, a power subsystem 160, a safety subsystem 170, an object detection subsystem 180, a dolly subsystem 190, and the like. Other trailer subsystems can also be employed and are not shown, such as a tire pressure monitoring subsystem, a suspension control subsystem, a lighting subsystem, and the like. The illustrated subsystems, units, and components can communicate with one or more remote facilities, such as fleet operations 100.

According to one embodiment, the subsystems 80 can include a service tool subsystem 110 that can be configured and employed to provide diagnostic, monitoring, configuration, and/or maintenance functions for the trailer unit 12 and one or more of the associated trailer subsystems. Specifically, the service tool subsystem 110 can perform system calibrations, initiate functional tests, or upload firmware and software updates to the vehicle control unit 20 and associated subsystems. The service tool subsystem 110 allows technicians, operators, or fleet managers to access system data, perform troubleshooting, update software or firmware, and adjust operating parameters. The service tool subsystem 110 can interface with the vehicle control unit 20 and other electronic control units to retrieve diagnostic trouble codes, sensor data, and performance logs, thereby enabling efficient fault detection and system analysis. In addition, the service tool subsystem 110 can be used to run functional tests, reset fault conditions, or calibrate selected components to ensure proper operation.

The service tool subsystem 110 can include a diagnostic and maintenance interface 112 that can be configured to enable a technician or fleet operator to interact with and manage the various onboard systems of the trailer unit 12. The service tool subsystem 110 can be operative to establish communication with the vehicle control unit 20 to retrieve diagnostic information therefrom as well as from other subsystems monitored or controlled thereby. The diagnostic and maintenance interface 112 can communicate with the vehicle control unit 20 through one or more suitable communication pathways, such as through the CAN bus 114. In this way, the service tool subsystem 110 can serves as the primary interface for ensuring ongoing reliability, maintainability, and regulatory compliance of the trailer unit and its subsystems. The vehicle control unit 20 can also be configured to aggregate diagnostic related data from one or more of the subsystems, such as the energy storage subsystem 30, the power distribution subsystem 40, the thermal management subsystem 50, the inverter, 60, the converter 70, the braking subsystem 120, the refrigeration subsystem 150, and the like, and to provide the data to the service tool unit 20 in a structured format for analysis. Conversely, the service tool unit 20 can transmit control instructions, update packages, or test commands to the vehicle control unit 20, which in turn manages the distribution of such instructions to the relevant subsystems. In this manner, the service tool unit 20 provides a comprehensive mechanism for performing diagnostics, system updates, and troubleshooting, thereby ensuring that the trailer unit 12 remains in optimal working condition.

The service tool subsystem 110 can generate and transmit a variety of data to the vehicle control unit 20 for processing. The data can include diagnostic related data, such as fault codes, error logs, or alerts indicating abnormal operating conditions within the trailer subsystems. The service tool subsystem 110 can also generate configuration related data, such as updated operating parameters, calibration settings, or software/firmware update commands that are to be applied to the VCU or other control units. Additionally, the service tool subsystem 110 can provide test data resulting from functional or system-level tests performed during maintenance procedures, including confirmation of component status or verification of corrective actions. Collectively, these data streams allow the vehicle control unit 20 to interpret the service technician's commands, implement necessary configuration changes, and update the operational status of the trailer unit to maintain reliable performance.

The trailer unit 12 can also include a braking subsystem 120 for providing braking functionality so as to ensure the safety and stability of the trailer unit while in motion. The braking subsystem 120 can include, for example, a trailer electronic braking system (TEBS) that electronically monitors and controls the application of braking pressure to the wheels of the trailer unit 12. In certain embodiments, the braking subsystem 120 may include both a primary TEBS 124 and a secondary TEBS 126 to provide redundancy and fail-safe operation. The primary TEBS 124 may be operative to receive braking demand signals and modulate pneumatic brake pressure to the individual wheels based on wheel speed and load data, while the secondary TEBS 126 may serve as a backup controller that assumes braking control in the event of a failure of the primary TEBS 124. To further enhance safety, the braking subsystem 120 can include a backup power supply 128 configured to maintain braking functionality in the event of a loss of trailer power, thereby ensuring that braking commands can still be executed during power interruptions or failures. The braking subsystem 120 can additionally include a power line carrier (PLC) adapter to enable communication of braking system data and control signals over the existing tractor-trailer electrical connection. This allows the braking subsystem 120 to exchange braking data with the tractor 90 and with the vehicle control unit 20 through the CAN bus 122, thereby facilitating coordinated braking across the entire tractor-trailer combination. The braking subsystem 120 can communicate a variety of operational and diagnostic braking related data to the vehicle control unit 20, including for example actual brake pressure values, calculated braking force applied to individual wheels, brake temperature data, wheel speed data, wear status of brake pads or discs, and load-dependent braking information. In certain embodiments, the braking related data can also include system fault codes, including sensor malfunctions, actuator faults, low air pressure warnings in pneumatic systems, communication errors, and emergency braking status information. Wheel speed and brake pressure data may be further employed by anti-lock braking (ABS) and electronic stability control (ESC) functionality to detect lockup or slippage and to dynamically adjust braking effort. The electronic braking system or the anti-lock braking system and the ESC can form part of the braking subsystem 120.

Further, the vehicle control unit 20 can generate and transmit braking control signals to the braking subsystem 120. The control signals can include braking force requests based on driver input (e.g., depression of the brake pedal), braking control signals generated by automated safety systems (e.g., adaptive cruise control, electronic stability programs, or automatic emergency braking systems), and load-adaptive braking commands that ensure braking effort is balanced relative to the trailer's cargo weight and axle configuration. The vehicle control unit 20 can transmit the braking control signals via the CAN buses 122 and 122A or other suitable communication pathways. The braking subsystem 120 is operative to interpret the received commands and apply appropriate braking pressure to the trailer's wheels in real time. The integration of the braking subsystem 120 with the vehicle control unit 20 ensures synchronized braking between the trailer unit 12 and the tractor 90, as well as with any associated dollies or additional trailers. By coordinating braking forces across the entire vehicle combination, the system prevents instability conditions such as jackknifing, trailer sway, or excessive brake lag, thereby ensuring compliance with applicable safety regulations and enhancing overall vehicle control.

The trailer unit 12 can also include a trailer communication subsystem (TCS) 130, which can be configured to provide trailer-to-tractor and trailer-to-trailer communication. The trailer communication subsystem 130 may be coupled to the vehicle control unit 20 to enable the exchange of operational data, status information, and control signals between the trailer unit 12, the towing tractor 90, and any additional connected trailers. The vehicle control unit 20 can serve as the central processor for interpreting data received from the TCS 130 and generating control or command signals in response thereto, thereby ensuring coordinated operation of the tractor-trailer combination. In certain embodiments, the TCS 130 can transmit to the vehicle control unit 20 data associated with braking coordination, braking system condition, wheel speed information, and braking fault status. The vehicle control unit 20 can process the data to ensure synchronized braking between the braking subsystem 120 and the tractor braking system, and to prevent conditions such as excessive braking lag, jackknifing, or trailer sway.

In addition, the TCS 130 may be operative to communicate data associated with energy management when the trailer unit 12 includes an e-axle, energy storage system 30, or other powered components. For example, the TCS 130 can provide the vehicle control unit 20 with information regarding trailer battery state-of-charge, power availability, and energy demand. The vehicle control unit 20 can in turn generate control signals instructing the TCS 130 to coordinate power draw or energy support with the tractor 90, such as requesting propulsion assist from the trailer e-axle or reducing trailer power consumption during specific driving conditions to optimize fuel efficiency or extend electric range.

The TCS 130 can further be configured to transmit to the vehicle control unit 20 data associated with trailer lighting, suspension control, and auxiliary systems. The vehicle control unit 20 can respond by generating control signals for routing via the TCS 130 to the relevant subsystems, such as commands to activate brake lights, turn signals, or marker lights in synchronization with tractor controls. Similarly, the TCS 130 may provide the vehicle control unit 20 with health and status data relating to trailer subsystems, including tire pressure, brake wear status, air suspension load data, and cargo condition (e.g., temperature or humidity in a refrigerated trailer). The vehicle control unit 20 can process this data to detect anomalies, generate alerts for the tractor operator, or transmit such information to a remote fleet management system.

In certain embodiments, the TCS 130 can support bidirectional communication for maintenance and diagnostic purposes. Diagnostic data collected by the TCS 130 from trailer subsystems may be aggregated and provided to the vehicle control unit 20 for processing, while the vehicle control unit 20 can generate control instructions or software update commands for delivery through the TCS 130 to trailer subsystems. In this manner, the TCS 130 functions as a communication gateway that allows the vehicle control unit 20 to manage trailer systems in real time, coordinate their operation with the tractor 90 and other trailers, and ensure optimal safety, performance, and regulatory compliance across the entire vehicle combination.

Still further, the trailer unit 10 can include an electronic axle (e-axle) subsystem 140, which can be configured to generate electrical power during trailer operation and to provide the generated power to at least one of an energy storage subsystem 30, the power distribution subsystem 40, or one of the other trailer subsystems. Specifically, the electronic axle subsystem 140 can be configured to provide supplemental propulsion, regenerative braking, and energy management functions for the trailer unit 12. The electronic axle subsystem 140 generally refers to an integrated assembly that combines an electric motor, power electronics, and transmission or gearing within or adjacent to one or more of the trailer's axles to directly deliver torque to the trailer wheels. The electronic axle subsystem 140 can include an electric traction motor, an inverter, a reduction gearbox, and associated control electronics, all housed in a compact unit designed for integration with the trailer axle. In certain embodiments, the electronic axle subsystem 140 can be coupled to the battery pack 34 of the onboard energy storage system 30, and managed through the power distribution subsystem 40 and thermal management subsystem 50.

The electronic axle subsystem 140 can be operative to partially or fully drive the wheels of the trailer unit 12, thereby reducing the load on the tractor 90 and improving fuel efficiency. By providing supplemental torque, the electronic axle subsystem 140 can assist the tractor 90 during acceleration, during hill climbs, or in other high-demand operating conditions, thereby reducing driveline strain and enabling smoother vehicle dynamics. Additionally, the electronic axle subsystem 140 can support regenerative braking, wherein the traction motor operates as a generator during deceleration or braking events to capture kinetic energy that can otherwise be dissipated as heat, and to convert such energy into electrical energy that may be stored in the trailer's battery system.

The electronic axle subsystem 140 can further exchange data and commands with the vehicle control unit 20 via one or more communication interfaces, such as via a CAN bus 142. Alternative communication interfaces can include an ethernet connection or a wireless communication link. The electronic axle subsystem 140 can transmit axle related data to the vehicle control unit 20 including, for example, motor torque output data, wheel speed data, inverter status data, energy consumption data, thermal status data, and regenerative braking energy recovery data. The vehicle control unit 20 can process the axle related data in real time to monitor e-axle performance and optimize overall vehicle operation. The vehicle control unit 20 can generate and transmit control signals to the electronic axle subsystem 140, including torque requests, regenerative braking level commands, power limit instructions, and mode control signals (e.g., switching between propulsion assist, coasting, or regenerative braking modes). By integrating propulsion and energy recovery capabilities directly into the trailer unit 12, the electronic axle subsystem 140 enables coordinated power sharing between the tractor 90 and the trailer unit 12, thereby improving fuel economy, reducing emissions, extending the operational range of electric towing vehicles, and enhancing drivability and safety of the tractor-trailer combination.

With further reference to FIG. 2, the trailer unit 12 can also include an optional refrigeration subsystem 150 that can be configured to control a temperature of a cargo space of the trailer unit within a selected temperature or temperature range during transport by receiving power from at least one of the energy storage subsystem 30, the power distribution subsystem 40, or an external power source 220. The refrigeration subsystem 150 can include a refrigeration unit housed within or coupled to the trailer unit 12, and can be operative to cool, freeze, or heat the trailer's cargo area depending on the requirements of the transported goods. In certain embodiments, the refrigeration subsystem 150 can include a compressor, evaporator, condenser, refrigerant lines, circulation fans, and associated control electronics configured to regulate the temperature and airflow throughout the cargo compartment. The refrigeration subsystem 150 can be further configured to ensure even distribution of conditioned air, thereby avoiding localized hot or cold spots that could compromise product quality.

In some embodiments, the refrigeration subsystem 150 can also manage humidity levels within the trailer cargo space to preserve goods sensitive to moisture, such as fresh produce, flowers, or specialty food products. Sensors within the subsystem can monitor temperature, humidity, refrigerant level, refrigerant pressure, compressor status, fan performance, and airflow conditions. The refrigeration subsystem 150 may also include diagnostic and monitoring capabilities, generating alarms in response to detected deviations from a prescribed temperature range, pressure fault conditions, low refrigerant levels, or component failures. Such alarms may be communicated to the driver of the tractor 90 or to a remote fleet operations center 100.

The refrigeration subsystem 150 can communicate with the vehicle control unit 20 via one or more communication interfaces, such as the CAN bus 152. The refrigeration related data generated by the refrigeration subsystem 150 and transmitted to the vehicle control unit 20 can include, for example, one or more of temperature data, humidity data, compressor operating status, refrigerant pressure and level, fan performance metrics, system power consumption, fault codes, alarm status, and overall subsystem health diagnostics. The vehicle control unit 20 can process the refrigeration related data to control the operation of the refrigeration subsystem, detect anomalies, or log system performance for fleet-level predictive maintenance. Further, the vehicle control unit 20 can generate and transmit command or control signals to the refrigeration subsystem 150 to control the operation thereof. The control signals can include adjustments to the target temperature setpoint, humidity setpoint, fan speed, and compressor duty cycle, as well as the initiation of specific operating modes such as economy mode, high-capacity cooling mode, or defrost mode. The vehicle control unit 20 can further control the allocation of trailer power resources to the refrigeration subsystem 150, balancing its energy demands against those of other subsystems such as the braking subsystem 120, the e-axle subsystem 140, or auxiliary loads. By integrating with the vehicle control unit 20, the refrigeration subsystem 150 enables real-time optimization of cargo environmental conditions, enhances operational efficiency of the trailer, and supports safe transport of perishable and temperature sensitive goods across a variety of operating environments.

The trailer unit 12 can further include a power subsystem 160 that can be configured to supply electrical energy to the trailer unit 12 and any associated subsystems, such as for example to the refrigeration subsystem 150, lighting systems, sensor networks, communication subsystems, and safety features including the braking subsystem 120. The power subsystem 160 can be configured as either a fully autonomous subsystem, incorporating its own energy storage and generation resources, or as a dependent subsystem that primarily relies upon power delivered from the tractor 90. In certain embodiments, the power subsystem 160 can operate in a hybrid configuration, whereby stored energy within the trailer supplements tractor-supplied power under high-demand conditions or provides backup power in the event of a disconnection or tractor power loss.

The power subsystem 160 can include one or more energy generation and/or storage elements 162, such as solar panels or additional battery packs, ultracapacitors, or hybrid storage devices, that provide sustained or rapid-response power to the trailer subsystems. In some embodiments, the battery packs may be associated with the e-axle subsystem 140, wherein the battery packs are operatively coupled to an e-axle power unit 144 that houses one or more electric propulsion motors, gear reduction elements, and power electronics. The e-axle power unit 144 can receive stored energy from the battery packs to drive the trailer wheels, or conversely, recharge the battery packs through regenerative braking events that capture kinetic energy and convert it to electrical energy during deceleration.

In certain embodiments, the power subsystem 160 can also include an untethered power unit 164, which enables the trailer unit 12 to generate or store power independently of the tractor 90. The untethered power unit 164 can be implemented as a modular energy storage and distribution system, containing one or more high-capacity battery packs, onboard charging electronics, and power conditioning modules. This configuration allows the trailer unit 12 to operate autonomously when disconnected from the tractor 90 or when parked, supplying power for functions such as refrigeration, lighting, communications, or security systems without reliance on an external power source. Additionally, the power subsystem 160 may optionally incorporate additional on-board power generation units, such as photovoltaic units (e.g., solar panels) 166, which can be mounted to the roof or sidewalls of the trailer unit 12, to provide renewable supplemental charging to the battery packs or ultracapacitors. The photovoltaic units can be configured to charge the energy storage devices 162 during daylight hours, thereby extending the operational range of the e-axle power unit 144, reducing reliance on external charging, and maintaining critical subsystems, such as refrigeration and communications when the trailer unit is idle. In certain embodiments, the photovoltaic units 166 may be integrated with maximum power point tracking (MPPT) electronics to optimize charging efficiency under varying sunlight conditions.

Further, each battery pack and energy storage module within the power subsystem 160 can be equipped with one or more embedded processors configured to monitor and manage the operation of the battery pack and photovoltaic units, including monitoring at the cell level for voltage, current, temperature, and state-of-charge parameters. The power subsystem 160 can further incorporate an optional hierarchical battery management architecture. For example, individual battery pack processors may communicate with a primary or control battery management processor located within the tractor or trailer, which in turn communicates with the vehicle control unit 20. This architecture enables centralized coordination of power flows, charging strategies, subsystem prioritization, and integration of supplemental power sources such as the e-axle power unit, the untethered power unit, and solar panels. The power subsystem 160 can also include associated power electronics, such as inverters, converters, distribution modules, and thermal management systems, to regulate and condition power for use by downstream loads. The power subsystem 160 can also be configured to communicate with the vehicle control unit 20 via one or more communication interfaces, such as the CAN bus 168. Data communicated from the power subsystem 160 to the vehicle control unit 20 can include real-time power consumption data for trailer systems, state-of-charge and state-of-health data for batteries, regenerative braking energy recovery data, temperature and thermal management data for energy storage components, energy source availability status, and subsystem diagnostic or fault code data. This information enables the vehicle control unit 20 to manage energy flow across the trailer unit and ensure optimal performance and reliability. The vehicle control unit 20 can also generate and transmit command or control signals to the power subsystem 160. The command signals can include, for example, commands to limit or increase power draw by selected trailer subsystems, activate or deactivate specific energy storage elements, initiate charging or discharging cycles, allocate energy between competing loads (e.g., refrigeration vs. braking assist), or switch operating modes (e.g., economy mode, performance mode, or idle storage mode). The vehicle control unit 20 can also control load-shedding strategies in the event of a low-power condition, thereby prioritizing safety-critical functions such as braking and lighting over nonessential loads. Accordingly, the power subsystem 160 serves as the central energy management platform for the trailer unit 12, ensuring reliable energy distribution, efficient use of stored and recovered energy, and seamless integration with the tractor or other coupled vehicles.

The trailer unit 12 can also include a safety subsystem 170 that is configured to ensure the safe operation of both the trailer unit 12 and the tractor 90, thereby protecting the driver, cargo, and other road users. The safety subsystem 170 can encompass a plurality of subsystems, sensors, and monitoring devices that provide active and passive safety functions to prevent accidents, improve handling, and ensure compliance with regulatory requirements. For example, the safety subsystem 170 can include braking-related safety features, such as anti-lock braking functions and stability control logic, which operate in conjunction with the braking subsystem 120 to prevent wheel lockup, mitigate trailer sway, and maintain vehicle stability during emergency maneuvers. The safety subsystem 170 can further incorporate a tire pressure monitoring system (TPMS) for monitoring individual tire pressures in real-time, as well as a centralized tire inflation system (CTIS) configured to selectively inject or release air into the trailer tires to maintain optimal inflation pressure under varying load and road conditions. The safety subsystem 170 can also include a bogie suspension (slider) adjustment system associated with the assembly of wheels and axles at the trailer rear. The bogie suspension system can be selectively adjusted to increase or decrease the trailer's wheelbase to accommodate cargo load conditions, balance axle loads, or comply with regulatory axle weight limits. In certain embodiments, the safety subsystem 170 can also include additional protective and monitoring components, such as a battery monitoring unit for detecting battery health and safety conditions, a door management system configured to detect unauthorized access to the trailer cargo area, and one or more jost sensors for detecting changes in trailer position or connection status in association with a fully automated coupling system (FACS). The safety subsystem 170 can further incorporate a Tractor-Trailer (TT) diagnostic system, which may include physical cables or wireless connections between the trailer and the tractor to facilitate the bidirectional exchange of diagnostic and safety-related data.

The safety subsystem 170 can be configured to communicate with the vehicle control unit 20 via one or more suitable communication pathways, such as via the CAN bus 172. The safety subsystem 170 can generate safety related data that can be transmitted from the safety subsystem 170 to the vehicle control unit 20. The safety related data can include, by simple way of example, one or more of tire pressure and temperature data, bogie suspension status, door open/close status, sensor fault codes, wheel slip or stability event data, and coupling integrity data from the jost sensors. The vehicle control unit 20 can process the safety-related data in real time and generate corresponding control or command signals. The control signals can include commands to adjust tire pressure through the CTIS, initiate stability or braking interventions, lock or unlock trailer doors, adjust bogie suspension settings, or issue alerts to the tractor driver or a remote fleet management system. Accordingly, the safety subsystem 170 can provide a comprehensive suite of functions for enhancing trailer safety and reliability, while the integration and communication with the central or main vehicle control unit 20 ensures centralized coordination, monitoring, and control across all safety-related subsystems of the trailer unit 12.

Still further, the illustrated trailer unit 12 can also include an object detection subsystem 180 that is configured to detect and monitor objects or obstacles in the trailer's surrounding environment, thereby enhancing safety during driving, reversing, parking, and maneuvering operations. The object detection subsystem 180 can employ a plurality of sensing technologies, such as LiDAR 182, radar 184, vision-based cameras 186, and various sensors such as infrared sensors, to create a comprehensive, multi-modal awareness of the trailer's external environment. By integrating data from different sensor modalities, the object detection subsystem 180 can generate a detailed perception map of the surroundings, enabling improved accuracy and redundancy under varying environmental conditions, such as rain, fog, or low-light scenarios.

The object detection subsystem 180 can provide numerous safety and operational benefits. For example, the subsystem can prevent or mitigate collisions by alerting the driver of the tractor to nearby vehicles, pedestrians, or fixed obstacles. In certain embodiments, the object detection subsystem 180 may further be configured to take corrective actions, such as automatically adjusting braking force or modifying trailer steering angle in systems equipped with active steering or e-axle torque vectoring. The object detection subsystem 180 can also provide blind spot monitoring capabilities by continuously monitoring lateral areas adjacent to the trailer to detect vehicles or objects that may be hidden from the driver's direct view. During low-speed maneuvering or parking operations, the object detection system 120 can provide proximity warnings or guide-path overlays, thereby assisting the driver in navigating tight spaces safely.

The object detection subsystem 180 can communicate with the vehicle control unit 20 via a suitable communication interface, such as the CAN buses 188. The object detection subsystem 180 can transmit real-time object related data to the vehicle control unit 20, including one or more of information about the position, distance, velocity, size, and classification of detected objects (e.g., vehicles, pedestrians, barriers). Additional object data can include blind spot status data, relative speed data, lane-departure related information, and detection confidence levels. The vehicle control unit 20 can process the object related data to generate alerts or warnings for the driver, to adjust vehicle speed or braking commands, or to coordinate with other trailer safety systems such as electronic braking, stability control, and the trailer communication subsystem 130 for tractor-trailer synchronization. Accordingly, the object detection subsystem 180 provides a layered safety architecture for the trailer unit 12, enabling both passive safety functions, such as driver alerts, and active safety interventions, such as automatic braking or trajectory adjustment. Integration with the vehicle control unit 20 ensures that the object detection data is centrally processed, cross-referenced with other subsystem data, and utilized for real-time decision-making to enhance overall trailer and tractor safety.

The trailer unit 12 can further include a dolly subsystem 190 for coupling together multiple trailer units 12 with a dolly 196. The dolly subsystem 190 can be implemented as a separate towable frame or chassis used in multi-trailer configurations to support and connect additional trailer units 198, such as in double or triple trailer combinations. The dolly subsystem 190 can include for example a fifth wheel coupling device, drawbar, or pintle hitch, as well as additional axles and wheels, to safely support and tow one or more trailer units positioned behind the lead trailer unit 12. By providing both structural support and load distribution, the dolly subsystem 190 can enhance the stability, maneuverability, and safety of multi-trailer arrangements, particularly under high-load or highway conditions.

The dolly subsystem 190 can also include integrated braking components, suspension assemblies, and lighting systems to ensure that the additional trailer units 12 remain synchronized with the lead trailer unit and tractor 90. In certain embodiments, the dolly subsystem 190 can incorporate electronic braking subsystems 120 (e.g., a trailer electronic braking system or TEBS), suspension controls for load leveling, and distributed power or lighting circuits. The dolly subsystem 190 can further be equipped with one or more sensors and electronic modules to enable monitoring of wheel speeds, axle loads, tire pressures, suspension status, and lighting functionality.

The dolly subsystem 190 can communicate with the vehicle control unit 20 of the trailer unit 12 via a suitable communication interface, such as via the CAN bus 192 or a suitable Ethernet connection. The dolly subsystem can generate dolly related data that can be exchanged between the dolly subsystem 190 and the vehicle control unit 20 and can include, for example, one or more of braking-related data (e.g., brake actuation status, brake force, and brake temperature), wheel and axle data (e.g., wheel speed, axle load, and weight distribution), suspension and load leveling information, tire pressure and temperature data, lighting and signaling status, and stability-related data such as yaw rate or lateral acceleration. The vehicle control unit 20 can process the dolly-related data in conjunction with trailer and tractor subsystem data to ensure safe and coordinated operation of the multi-trailer system. In response, the vehicle control unit 20 can generate control or command signals for the dolly subsystem 190, including commands to activate braking functions, adjust suspension settings, modulate tire inflation or deflation through a centralized tire inflation system (CTIS), synchronize lighting and turn signals, or initiate stability control interventions. In certain embodiments, the dolly subsystem 190 can also support diagnostic reporting, transmitting fault codes or system health information to the vehicle control unit 20 for storage, processing, or transmission to the tractor or fleet management system. Accordingly, the dolly subsystem 190 provides structural and functional integration for multi-trailer combinations, while electronic communication with the vehicle control unit 20 ensures that braking, stability control, suspension, and lighting functions of the dolly subsystem 190 are synchronized with those of the lead trailer unit 12 and tractor 90, thereby enhancing safety, performance, and regulatory compliance in multi-trailer operations.

The trailer unit 10 can also include a communication subsystem 200 that can be configured to integrate telecommunications, GPS data, and on-board diagnostics (OBD) technology to monitor, manage, and communicate real-time data about the performance, location, operational status, and other details of the trailer unit 10. The information can be shared with a remote facility, such as a fleet operation center 210. The communication subsystem 200 can communicate with the vehicle control unit 12 via any suitable interface, such as via the CAN bus 202, and the information exchanged with the fleet operations center 210 can include location and route tracking data (e.g., location, speed, and travel routes), and diagnostics and maintenance data (e.g., brake wear and performance data, tire pressure and condition data, axle load and weight distribution data, refrigeration unit status data, battery health and data). The data can be employed by the fleet operations center 210 to allow for predictive maintenance so as to reduce trailer downtime due to system failures.

The trailer unit 12 can include a number of different communication pathways (e.g., CAN buses) that all the subsystem and units of the trailer unit 12 can employ to communicate with the vehicle control unit 12 and with each other. The communication pathways can also allow the trailer unit 12 to communicate with the dolly subsystem 190 and the next trailer unit 198, as well as with the tractor 90. The vehicle control unit 20 can interface with all of the subsystems and units shown in FIGS. 1 and 2 and can constantly monitor the state of the subsystems. The vehicle control unit 20 can also monitor communication traffic over the communication pathways to determine if the vehicle control unit 20 needs to provide command or control signals, process selected data, or override selected data. The vehicle control unit 20 can function as the main controller of the software enabled electrified trailer unit and is responsible for managing various aspects of the performance, functionality, and safety of the trailer. The vehicle control unit 20 is also responsible for managing and coordinating various systems and subsystems within the trailer unit 12, and specifically the controllers of the subsystems. The vehicle control unit 20 can interact with different controllers of the trailer subsystems to ensure the efficient and safe operation of the trailer unit 12. The vehicle control unit 20 can be configured to interact with and aggregate data from the different controllers and also interfaces with the tractor 90 and other trailer units 198. The vehicle control unit 20 can utilize various communication protocols, such as CAN and Ethernet, to establish communication with the controllers. The vehicle control unit 20 helps monitor and maintain the health status of the trailer components by receiving and analyzing data from the various controllers. The vehicle control unit 20 also helps ensure that the trailer unit 12 operates optimally by monitoring systems such as motion control systems, battery health, cargo temperature, and battery state of charge. The vehicle control unit 20 thus serves as a central or main processing and communication hub between the various subsystems and receives data from sensors and transducers installed in various systems and components of the trailer unit 12.

The main vehicle control unit 20 serves as the central controller and commanding entity for the trailer unit 12, providing supervisory control, coordination, and communication among the various subsystems. In operation, the vehicle control unit 20 monitors and controls the energy storage subsystem 30 (e.g., the battery management system (BMS)) including control of the main battery contactor and pre-charge sequence, while collecting and reporting battery statistics such as state of charge, temperature, and fault conditions. The vehicle control unit 20 further monitors and controls the power distribution subsystem 40 (PDU) for selecting appropriate battery and power connections and reporting subsystem status depending on whether the subsystem is in a charging or discharging mode. In coordination with the battery management system 36 and one or more controllers (e.g., electronic control units (ECUs)) of the subsystems, the vehicle control unit 20 can also monitor and control the thermal management subsystem 50 to maintain temperature limits and report related data. The vehicle control unit 20 also interfaces with any on-board charger (OBC) to ensure proper BMS and PDU configurations during charging, and monitors and controls the inverter/charger operation with the correct PDU, BMS, and transfer switch configuration when in charge mode. Additional functions performed by the vehicle control unit 20 can include management of interlock functions, runtime data collection, and wakeup operations. The vehicle control unit 20 communicates with the distributed subsystems of the trailer unit 12 through multiple controller area network (CAN) buses and gateways, enabling coordination with subsystem units, such as the BMS, PDU, inverter, short power transfer switch, converter, e-axle, telematics gateway, refrigeration subsystem 150, and other auxiliary ECUs, thereby serving as the centralized controller and platform for power, safety, and system integration of the trailer unit 12.

The illustrated vehicle control unit 20 also serves as the central supervisory controller for the trailer unit 12, coordinating subsystem states, operational priorities, and battery-based power management. According to one operational methodology employed by the vehicle control unit 20, in a default operating condition, activation of the ignition switch of the trailer unit 12 powers on the refrigeration subsystem 150, unless the vehicle control unit 20 determines that an alternate state, such as a charging mode, has a higher priority. The prioritization of operational states allows the vehicle control unit 20 to dynamically adapt to conditions such as energy availability, charging opportunities, and load demands.

The vehicle control unit 20 manages communication interfaces with the foregoing plurality of trailer subsystems, including the battery management subsystem 30, the power distribution subsystem 40, the thermal management subsystem 50, inverter subsystem 60, and the on-board charger. Through these interfaces, the vehicle control unit 20 performs both monitoring and control functions. For example, with respect to the battery management subsystem 36 of the energy storage subsystem 30, the vehicle control unit 20 can monitor the status of selected switches, such as the power primary switch 32 (e.g., high-voltage contactor). The vehicle control unit 20 can monitor the overall status, pre-charge status, and battery statistics such as state-of-charge and fault data, while issuing control commands to open or close the switch. Similarly, with the power distribution subsystem 40, the vehicle control unit 20 can be configured to monitor the states of a primary switch 42 and a secondary switch 44 and generate and issue commands to establish or disconnect the switches so as to open or close associated power paths. In connection with the thermal management subsystem 50, the vehicle control unit 20 can monitor the operating modes of the trailer unit, such as the refrigeration subsystem 150. The operating modes can include shutdown, refrigeration, heating, and self-circulation, and can set target temperature ranges or initiate shutdowns in fault conditions. With the inverter subsystem 60, the vehicle control unit 20 can monitor and control operating states (e.g., idle, sleep, charging, motor drive, balancing), status, and fault conditions, while setting operating limits such as voltage and frequency. In addition, the vehicle control unit 20 monitors the state and fault conditions of the on-board charger to ensure coordinated charging operations.

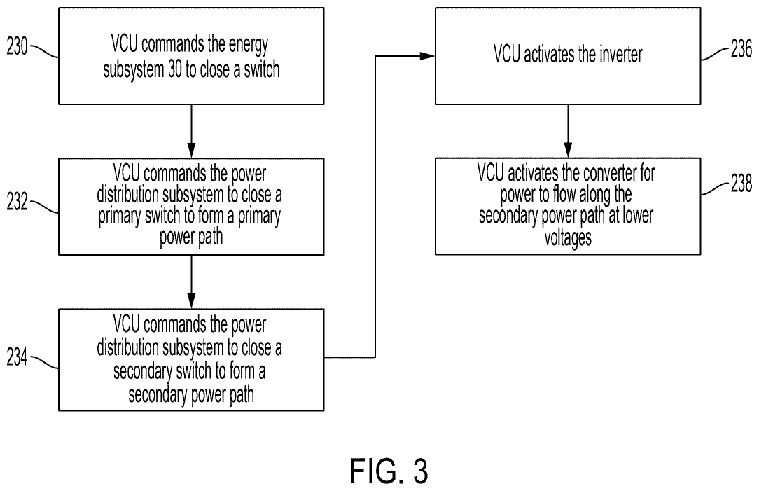

In a battery power-source management mode, as shown in FIGS. 1 and 3, the vehicle control unit (VCU) 20 is responsible for coordinating and establishing the proper power flow paths to both the refrigeration subsystem 150 and the various peripheral subsystems of the trailer unit 12. To supply power to the refrigeration subsystem 150, the vehicle control unit 20 can initiate a defined sequence of operations that ensures safe and reliable delivery of energy to the refrigeration subsystem. First, the vehicle control unit 20 sends command signals to the energy storage subsystem 30 to initially close a primary switch 32 (e.g., a high-voltage contactor) associated therewith, thereby making the stored energy of the high-voltage battery accessible, step 230. The primary switch can be a heavy-duty electrically controlled switch designed to connect or disconnect the high-voltage battery pack of the subsystem 30 from the rest of the subsystems of the trailer unit 12. Unlike a simple mechanical switch, the high-voltage primary switch can be designed to safely handle the high currents and voltages typical of electric propulsion or auxiliary systems, often in the range of about 200-800 V, depending on the system. When the vehicle control unit 20 sends a command to “close” the switch, the switch engages, allowing current to flow from the battery packs in the subsystem 30 to downstream subsystems of the trailer unit 12, such as to the power distribution subsystem 40, the inverter 60, or the DC/DC converter 70. When the switch is disposed in the “open” position, the battery pack is electrically isolated, which prevents unintended power flow, protects service personnel, and ensures safety during faults or shutdowns.

Next, the vehicle control unit 20 instructs the power distribution subsystem 40 to close both a main or primary switch 42 and a secondary switch 44, creating primary and secondary power paths needed for downstream components of the trailer unit 12. More specifically, the vehicle control unit 20 can instruct the power distribution subsystem 40 to close the primary switch 42 to form a primary power distribution power path, step 232. The primary power distribution power path connects the high-voltage battery pack 34 of the energy management subsystem 30 to a power distribution bus and delivers energy or power to selected loads, such as to the inverter subsystem 60 and to the converter subsystem 70. As such, the energy management subsystem 30 supplies power to the inverter 60 and to the converter 70. Further, the vehicle control unit 20 can generate and transmit a control signal to the power distribution subsystem 40 to close the secondary switch 44 to form a secondary power path, step 234. Closing the secondary switch 44 establishes the secondary power path that can be used to supply power to dedicated loads, such as the refrigeration subsystem 150 or other selected trailer subsystems. In certain embodiments, the secondary switch 44 can also enable alternate routing of power depending on whether the trailer unit 12 is operating in propulsion, charging, or standby mode. By controlling both the primary and secondary switches 42, 44, the vehicle control unit 20 ensures that high-voltage power is delivered safely and efficiently to the required subsystems, while also providing operational flexibility and redundancy in the power distribution architecture of the trailer unit.

Once the high-voltage power paths are established, the vehicle control unit 20 can then activate the inverter 60, which converts the direct current (DC) power from the battery pack 34 and passing along the primary power path into alternating current (AC) power suitable for operating the refrigeration subsystem 150, step 236. Specifically, the converted power then flows along the secondary power path to the refrigeration subsystem 150. In certain configurations, the vehicle control unit 20 can also command a shore power transfer switch to close, thereby completing the energy path from the inverter 60 to the refrigeration subsystem 150 and ensuring uninterrupted operation of the refrigeration unit under all conditions. The shore power switch can allow the trailer unit to supply power to the subsystems by on-board power sources, such as the battery packs of the energy management subsystem 30 or from off-board power, such as when the vehicle is parked.

In addition to managing power flow to the refrigeration subsystem 150, the vehicle control unit 20 can also control the delivery of power to lower-voltage peripheral subsystems, such as sensors, safety devices, lighting, or communication modules. To accomplish this, the vehicle control unit 20 again generates and transmits a control signal to control or instruct the energy storage subsystem 30 to close the primary switch 32 and generates and transmits a control signal to controls or instruct the power distribution subsystem 40 to close the primary switch 42, establishing the high-voltage primary power paths in the trailer unit 12. The vehicle control unit 20 can then activate the DC/DC converter 70 via a separate control signal. The converter subsystem an include a converter for changing the power level by stepping down the high-voltage DC power into regulated lower-voltage DC power (e.g., 12V or 24V), suitable for peripheral equipment, step 238. Through this coordinated control, the vehicle control unit 20 dynamically manages both high-voltage and low-voltage power distribution within the trailer unit 12, ensuring that each subsystem receives the proper form and level of power or energy when needed. This approach enables efficient use of the onboard energy storage 34, provides safe sequencing of switches and power electronics, and allows the trailer unit 12 to autonomously power selected trailer functions such as refrigeration and safety systems even when not directly supported by the tractor.

The vehicle control unit 20 further performs cross-system coordination functions, including data logging, runtime statistics collection, and user interface management through a telematics gateway (e.g., the communication subsystem 200 and fleet operations 210). The telematics gateway enables remote data capture, fleet-level visibility, and over-the-air (OTA) monitoring of sensors and subsystems. During all operational modes, the vehicle control unit 20 continuously monitors the health and status of each subsystem in the power paths. In the event of a detected fault, the vehicle control unit 20 can be configured to analyze the severity of the fault, initiate controlled shutdowns of affected subsystems if necessary, and communicate the event data and power-flow status to the communication subsystem 200 for diagnostics and fleet management. Accordingly, the vehicle control unit 20 serves as the central coordinating entity for the trailer unit 12, integrating subsystem interfaces, managing operational priorities, controlling power flows, and safeguarding trailer performance and safety under a wide range of operating conditions.

In certain operating scenarios, the trailer unit 12 can be connected to an external power source (e.g., AC power grid), referred to as a shore power source 220. When power from the shore power source 220 is available, the vehicle control unit 20 can be configured to manage the distribution of this external power to ensure uninterrupted operation of the refrigeration subsystem 150 and any other trailer subsystems. In addition to supplying real-time power to these loads from the shore power source, the vehicle control unit 20 can also regulate charging of the battery pack 34 of the onboard energy storage subsystem 30, thereby optimizing battery performance, extending service life, and reducing reliance on stored energy while docked or idle.

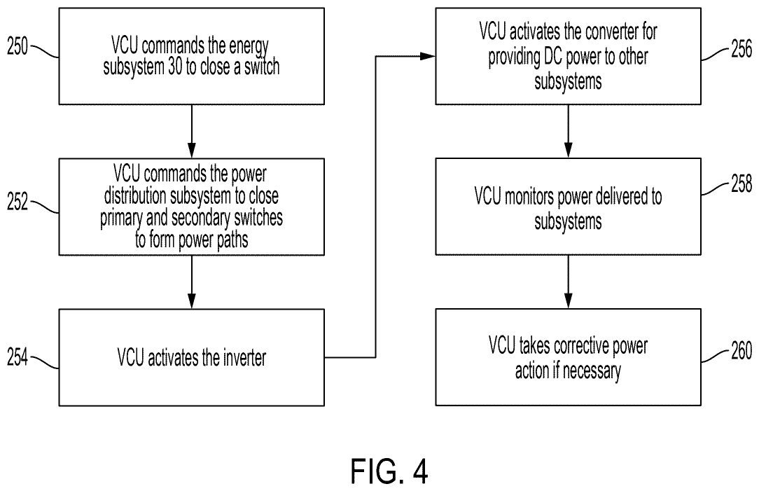

To establish a power flow path from the external shore power source 220 to the refrigeration subsystem 150 and other trailer subsystems, the vehicle control unit 20 can perform a series of coordinated functions and operations. As shown for example in FIG. 4, the vehicle control unit 20 can instruct or command the energy storage subsystem 30 to close the power switch 32, step 250. This action prepares the battery pack 34 for potential charging and ensures that the high-voltage bus is energized for controlled interaction with the energy storage subsystem 30 and the other subsystems. Next, the vehicle control unit 20 instructs the power distribution subsystem 40 to close both the primary power switch 42 and the secondary power switch 44, thereby establishing the primary power path 46 and the secondary power path 48 required for delivery of power to the refrigeration subsystem 150 and associated loads (e.g., other subsystems), step 252.

The vehicle control unit 20 can then activate the inverter subsystem 60 to enable conversion between direct current (DC) power from the energy storage subsystem 30 and alternating current (AC) power as needed for compatibility with the refrigeration subsystem 150 and other trailer equipment, step 254. In configurations where a shore power transfer switch is employed, the vehicle control unit 20 can control the switch to selectively route the incoming external AC power into the trailer's power distribution architecture. This switching action ensures that shore power is utilized safely and efficiently, preventing overlap or conflict between internal and external power sources. Additionally, the vehicle control unit 20 can engage the DC/DC converter subsystem 70 to regulate voltage levels and provide stable low-voltage DC power (e.g., 12 VDC or 24 VDC) for peripheral trailer units, step 256. Through the foregoing coordinated power operations, the vehicle control unit 20 can ensure relatively seamless utilization of shore power from the shore power source 220 while maintaining proper system integration with onboard energy storage, such as with the energy storage subsystem 30.

Further, during the shore power operation, the vehicle control unit 20 can continuously monitor the state and health of each component in the power flow path, including the battery pack 34 of the energy storage subsystem 30, the power distribution subsystem 40, the inverter 60, the converter 70, and the like, step 258. The vehicle control unit 20 can evaluate operational parameters, fault conditions, and performance limits in real time to detect abnormal states. Upon detection of a fault, the vehicle control unit 20 can determine the severity of the condition and, if necessary, initiate a power corrective action, such as for example a controlled shutdown or isolation of affected components or subsystems to preserve system integrity and prevent damage, step 260. Diagnostic information, including the nature of the fault and the resulting power flow status, is then communicated to the communication subsystem 200. This allows for remote monitoring such as by fleet operations 210, logging, and further analysis to support preventive maintenance and fleet-level system oversight.

The illustrated trailer unit 12 can also be equipped with an electric axle subsystem 140 configured to generate electrical energy during operation, such as when the trailer unit is in motion. The energy recovered by the electric axle subsystem 140 can be used to supply power directly to trailer subsystems or, when appropriate, to recharge the onboard battery pack 34 of the energy storage subsystem 30. The vehicle control unit 20 can be configured to manage and prioritizes the distribution of this e-axle-generated power to optimize trailer performance, improve energy efficiency, and reduce reliance on external or stored energy sources.

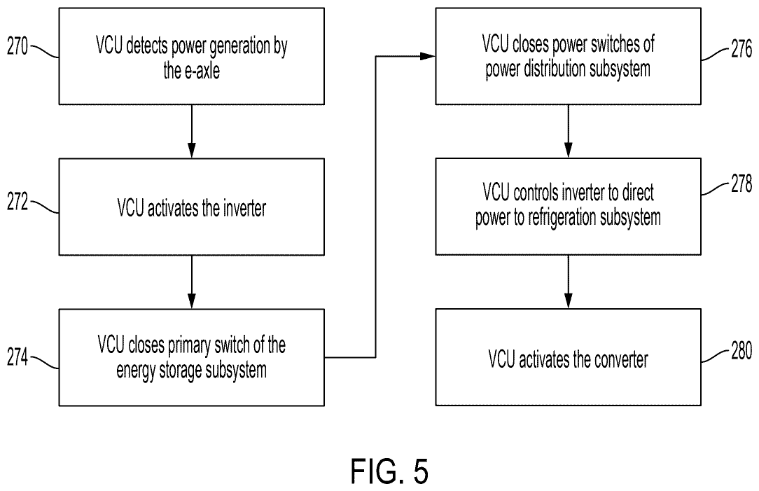

As shown for example in FIG. 5, to establish the flow of power from the electric axle subsystem 140 to downstream components and subsystems, the vehicle control unit 20 coordinates several operations. First, the vehicle control unit 20 monitors the electric axle subsystem 140 to detect power generation, step 270. If power generation is detected, then the vehicle control unit 20 activates the inverter 60, ensuring that electrical energy is conditioned for use by other trailer subsystems, step 272. Next, the vehicle control unit 20 can instruct the energy storage subsystem 30 to close the primary power switch 32, thereby establishing the high-voltage power bus or path for controlled energy distribution, step 274. The vehicle control unit 20 then directs the power distribution subsystem 40 to close both the primary power switch 42 and the secondary power switch 44, establishing the primary and secondary power paths 46, 48 necessary for delivering power to high power demand trailer subsystems, such as the refrigeration subsystem 150, step 276. The vehicle control unit 20 then controls the operation of the inverter subsystem 60 so as to be able to route or transfer power generated by the electric axle subsystem 140 to the refrigeration subsystem 150 for continuous cooling operation, step 278. Additionally, the vehicle control unit 20 can activate the converter 70 to regulate voltage levels and either charge the onboard battery pack 34 or provide stable low-voltage DC power (e.g., 12 VDC or 24 VDC) to selected subsystems, step 280. Through these coordinated steps, the vehicle control unit 20 can ensure that the energy generated by the electric axle subsystem 140 is effectively harnessed and distributed throughout the trailer unit 12. During power generation by the electric axle subsystem 140, the vehicle control unit 20 can also continuously monitor the operating state and health of each subsystem within the power flow path, including the inverter subsystem 60, the energy storage subsystem 30, the power distribution subsystem 40, and the converter subsystem 70. The real-time data can be processed and analyzed by the vehicle control unit 20 to detect abnormal conditions, inefficiencies, or fault states. If a fault is identified, the vehicle control unit 20 can evaluate the severity and may initiate a power corrective action, such as a controlled shutdown or isolate affected subsystems to protect the overall trailer power system. Diagnostic data, including fault details and resulting changes in power flow, can be communicated to the communication subsystem 200 to support remote diagnostics, logging, and further analysis.

Although shore power connections provide reliable energy for the various subsystems of the trailer unit 12, there are operational scenarios in which access to external power sources may be limited or unavailable. To address this issue, the vehicle control unit 20 can be configured to employ one or more logical techniques for managing battery usage, optimizing power consumption, and supporting informed decision-making by operators. For example, according to one logical technique, the vehicle control unit 20 can continuously monitor the state of charge (SOC) of the onboard battery pack 34 of the energy storage subsystem 30 along with historical and real-time power consumption data from connected subsystems. Using this information, the vehicle control unit 20 can generate real-time estimates of the remaining operational range based on current energy usage patterns. To further extend operational range, the vehicle control unit 20 can employ energy efficiency strategies, such as dynamically managing the operation of the refrigeration subsystem 150 based on real-time temperature requirements, selectively activating low-power modes for non-critical subsystems when not actively needed, and optimizing charging cycles to promote long-term battery health and maximize usable energy capacity.

Further, to support the operator of the trailer unit 12, the vehicle control unit 20 can be configured to integrate with a user interface that displays real-time power and range data. For example, the interface can provide the operator with an easily accessible estimate of the remaining operational range on battery power, enabling proactive planning of trailer operations. In addition, the interface may display a detailed breakdown of both current and historical power consumption across different subsystems, allowing the user to identify which systems are consuming the most energy and apply targeted strategies for optimization.

The vehicle control unit 20 can also facilitate contingency planning in battery-only operational scenarios. For example, the vehicle control unit 20 can issue low-battery alerts when the state of charge reaches predefined thresholds, giving the operator sufficient time to adjust usage patterns, seek external power, or implement additional energy-saving measures. The vehicle control unit 20 can further implement an optional user-selectable power saving mode in which important trailer subsystems are prioritized while non-essential subsystems are placed into low-power or standby states or modes. This functionality enables the trailer unit 12 to extend its operational range during periods of limited battery power availability, thereby reducing downtime and improving reliability of the trailer unit during use.

In FIGS. 1 and 2, the connecting lines represent either communication pathways (such as CAN buses) or power paths, or both. For ease of illustration and understanding, a single connecting line or pathway is shown. Those of ordinary skill in the art will readily recognize that power pathways require suitable electrical connections and communication pathways require suitable communication connections. In the illustrated trailer unit 12, the power paths established therein represent controlled electrical pathways through which energy is delivered from one subsystem to another. The power paths are formed when the vehicle control unit commands the closure of the switches, low-voltage relays, transfer switches, or other power distribution components within the power distribution subsystem. Once closed, these devices complete discrete electrical circuits that allow current to flow from an energy source, such as the battery packs 34 of the energy storage subsystem 30, to downstream trailer loads. By way of example, one power path may be established from the battery packs 34 through the switches 32, 42 (e.g., high-voltage contactors) and the power distribution subsystem 40 to the inverter subsystem 60, which converts direct current (DC) power to alternating current (AC) power for delivery to the refrigeration subsystem 150. Another power path can be formed from the shore power subsystem 220 that includes a shore power transfer switch to supply AC power to the refrigeration subsystem 150 and, in certain configurations, to simultaneously provide charging current to the battery packs 34. Yet another power path may be formed from the electronic axle subsystem 140 through the inverter subsystem 60 and the power distribution subsystem 40 to deliver energy to the refrigeration subsystem 150, or alternatively to route power to the converter subsystem 70 for charging the battery packs 34. Additional power paths can be configured to direct regulated low-voltage power from the converter subsystem 70 to peripheral systems such as sensors, telematics equipment, or control modules. The power paths are electrical in nature and are typically physically distinct from the Controller Area Network (CAN) buses. The CAN buses function as digital communication pathways that transmit control commands, operating parameters, and monitoring data between the vehicle control unit 20 and the various subsystems. In this manner, the CAN buses provide the information flow that governs the establishment, operation, and monitoring of the power paths, while the electrical power paths carry the actual energy or power needed to operate trailer systems.

It is further understood that the vehicle control unit 20 can include one or more processors and suitable memory, such as a non-transitory computer readable memory element that can store suitable instructions that can be executed by the processor. Similarly, one or more of the subsystems of the trailer unit 12 can employ dedicated controllers that communicate with the main or central vehicle control unit 20. The vehicle control unit 20 is configured to control the subsystem controllers.

It is to be understood that although the present invention has been described above in terms of particular embodiments, the foregoing embodiments are provided as being illustrative only and are not intended to limit or define the scope of the invention. Various other embodiments, including but not limited to those described herein are also within the scope of the claims and current invention. For example, the foregoing subsystems, elements, units, modules, tools, models, and components described herein may be further divided into additional components or sub-components or units or joined together to form fewer components for performing the same functions.

Any of the functions disclosed herein may be implemented using means for performing those functions. Such means include, but are not limited to, any of the components or units disclosed herein, as well as known mechanical, electronic and computing devices and associated components.

The techniques described herein in connection with, for example, the vehicle control unit 20, may be implemented as an electronic device in suitable hardware, one or more computer programs tangibly stored on one or more computer-readable media, firmware, hardware or any combination thereof. The techniques described herein may be implemented in one or more computer programs executing on (or executable by) the vehicle control unit 20 having any combination of any number of the following: a processor, a storage medium readable and/or writable by the processor (including, for example, volatile and non-volatile memory and/or storage elements), memory, an input device, an output device, and a display. Program code may be applied to input entered using the input device to perform the functions described and to generate output using the output device. The units and subsystems of the trailer system 10 can be implemented by suitable electronic and mechanical devices. The term electronic device as used herein can refer to any device, such as a computer, smart phone, server, controller and the like, that includes a processor and a computer-readable memory or storage capable of storing computer-readable instructions, and in which the processor is capable of executing the computer-readable instructions in the memory.

Any claims herein which by implication or affirmatively require an electronic device such as a computer or server, a processor, a memory, storage, controller or similar computer-related elements, are intended to require such elements, and should not be interpreted as if such elements are not present in or required by such claims. Such claims are not intended, and should not be interpreted, to cover methods and/or systems which lack the recited computer-related elements unless otherwise set forth in the claims. For example, any method claims herein which recites that the claimed method is performed or implemented by an electronic device, controller or control unit, a processor, a memory, and/or similar computer-related element, should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the computer-related element(s). Such a product claim should not be interpreted, for example, to encompass a product that does not include computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage or memory device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

It should be appreciated that various concepts, systems and methods described above can be implemented in any number of ways, as the disclosed concepts are not limited to any particular manner of implementation or system configuration. Examples of specific implementations and applications that are discussed herein are primarily for illustrative purposes and for providing or describing the operating environment of the system of the present invention. The trailer system 10 and/or elements or units thereof can employ one or more electronic or computing devices, such as one or more servers, clients, computers, laptops, smartphones and the like, that are networked together, or which are arranged so as to effectively communicate with each other. The network can be any type or form of network. The devices can be on the same network or on different networks. In some embodiments, the network system may include multiple, logically grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like. The systems 10 and 140 or any associated units or components of the system can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device. In one embodiment, the server may be referred to as a remote machine or a node. In another embodiment, a plurality of nodes may be in the path between any two communicating servers or clients.

We claim:

1. A trailer unit for transporting cargo, comprising
a plurality of trailer subsystems including
an energy storage subsystem having one or more battery packs for storing power therein and a first primary switch for forming, when actuated, a battery power path, wherein the energy storage subsystem generates battery related data,
a power distribution subsystem for distributing power from the energy storage subsystem to one or more of the plurality of trailer subsystems, the power distribution subsystem having a second primary switch for forming, when actuated, a power distribution power path and a secondary switch for forming, when actuated, a secondary power path, wherein the power distribution subsystem generates power related data,
a thermal management subsystem that is configured to control a temperature of at least a portion of the energy storage subsystem, wherein the thermal management subsystem generates thermal related data,
an inverter subsystem for inverting the power from the energy storage subsystem for use by one or more of the plurality of trailer subsystems, and
a converter subsystem for converting the power from the energy storage subsystem from a first power level to a second different power level suitable for use by one or more of the plurality of trailer subsystems, and
a main vehicle control unit coupled to each of the plurality of trailer subsystems for communicating with and for controlling each of the plurality of trailer subsystems,
wherein the main vehicle control unit is configured to receive and to process the battery related data to control the first primary switch, the power related data to control the second primary switch and the secondary switch, and the thermal related data to control the temperature of the portion of the energy storage subsystem.

2. The trailer unit of claim 1, wherein the thermal management subsystem is configured to regulate a temperature of the one or more battery packs of the energy storage subsystem.

3. The trailer unit of claim 2, wherein the thermal management subsystem is configured to regulate a temperature of one or more of the plurality of trailer subsystems in addition to the energy storage subsystem.

4. The trailer unit of claim 3, wherein the vehicle control unit, based on the thermal related data, is configured to switch the thermal management subsystem into one of a plurality of operating modes.

5. The trailer unit of claim 2, wherein the vehicle control unit is configured to monitor and to control an operating state of the inverter subsystem.

6. The trailer unit of claim 5, wherein the vehicle control unit is configured to control operation of the converter subsystem.

7. The trailer unit of claim 6, wherein the plurality of trailer subsystems further comprises a service tool subsystem configured to provide diagnostic, configuration, and testing functions for the trailer unit, and wherein the service tool subsystem generates diagnostic related data, configuration data and testing data for processing by the vehicle control unit.

8. The trailer unit of claim 7, wherein the plurality of trailer subsystems further comprises a braking subsystem for providing braking functionality, wherein the braking subsystem generates braking related data, and wherein the vehicle control unit receives and processes the braking related data and generates braking control signals for controlling the braking subsystem.

9. The trailer unit of claim 8, wherein the plurality of trailer subsystems further comprises an electronic axle subsystem configured to generate regenerative power during trailer operation and to provide the regenerative power to at least the energy storage subsystem.

10. The trailer unit of claim 9, wherein the plurality of trailer subsystems further comprises a refrigeration subsystem that is configured to control a temperature of the cargo space by receiving power from at least one of the energy storage subsystem and the power distribution subsystem.

11. The trailer unit of claim 10, wherein the vehicle control unit is configured to control the power supplied to the refrigeration subsystem.

12. The trailer unit of claim 11, wherein the vehicle control unit can be configured to generate and to transmit a first control signal to the energy storage subsystem to close the first primary switch to allow the power to flow from the one or more battery packs along the battery power path to one or more of the plurality of trailer subsystems.

13. The trailer unit of claim 12, wherein the vehicle control unit can be configured to generate and to transmit a second control signal to the power distribution subsystem to close the second primary switch to form the power distribution power path to allow the power from the one or more battery packs of the energy storage subsystem to flow to the inverter subsystem and to the converter subsystem.

14. The trailer unit of claim 13, wherein the vehicle control unit can be configured to generate and transmit a third control signal to the power distribution subsystem to close the secondary switch to form the secondary power path to provide power from the one or more battery packs to the refrigeration subsystem.

15. The trailer unit of claim 14, wherein the vehicle control unit is configured to generate an inverter control signal to activate the inverter subsystem, and wherein the one or more battery packs produces direct current (DC) power that passes along the power distribution power path to the inverter subsystem, and wherein the inverter subsystem converts the DC power to alternating current (AC) power, and wherein the AC power passes along the secondary power path to the refrigeration subsystem.

16. The trailer unit of claim 15, wherein the DC power from the one or more battery packs is at a first DC power level, wherein the vehicle control unit is configured to generate a converter control signal to activate the converter subsystem, and wherein the converter subsystem steps down the DC power from the first DC power level to a second lower DC power level.

17. The trailer unit of claim 16, wherein the vehicle control unit is configured to monitor one or more of the plurality of trailer subsystems for a selected power fault, and if detected, initiate a power corrective action.

18. The trailer unit of claim 16, wherein the electronic axle subsystem is configured to generate the regenerative power and wherein the vehicle control unit is configured to communicate with the electronic axle subsystem, and wherein if the vehicle control unit detects that the electronic axle subsystem is generating the regenerative power, the regenerative power is conveyed to the refrigeration subsystem via at least the power distribution power path.

19. A method for controlling a plurality of trailer subsystems in a trailer unit having a cargo space, wherein the plurality of trailer subsystems includes
an energy storage subsystem having one or more battery packs for storing power therein and a first primary switch for forming, when actuated, a battery power path, wherein the energy storage subsystem generates battery related data,
a power distribution subsystem for distributing power from the energy storage subsystem to one or more of the plurality of trailer subsystems, the power distribution subsystem having a second primary switch for forming, when actuated, a power distribution power path and a secondary switch for forming, when actuated, a secondary power path, wherein the power distribution subsystem generates power related data,
a thermal management subsystem that is configured to control a temperature of at least a portion of the energy storage subsystem, wherein the thermal management subsystem generates thermal related data,
an inverter subsystem for inverting the power from the energy storage subsystem for use by one or more of the plurality of trailer subsystems, and
a converter subsystem for converting the power from the energy storage subsystem from a first power level to a second different power level suitable for use by one or more of the plurality of trailer subsystems,
an electronic axle subsystem configured to generate regenerative power during trailer operation and to provide the regenerative power to at least the energy storage subsystem, and
a refrigeration subsystem that is configured to control a temperature of the cargo space by receiving power from at least one of the energy storage subsystem and the power distribution subsystem, and
wherein the trailer unit includes a main vehicle control unit coupled to each of the plurality of trailer subsystems for communicating with and for controlling each of the plurality of trailer subsystems, wherein the main vehicle control unit is configured to receive and to process the battery related data to control the first primary switch, the power related data to control the second primary switch and the secondary switch, and the thermal related data to control the temperature of the portion of the energy storage subsystem,
the method comprising
generating, with the main vehicle control unit, a first control signal and transmitting the first control signal to the energy storage subsystem to close the first primary switch to allow the power to flow from the one or more battery packs along the battery power path,
generating, with the main vehicle control unit, a second control signal and transmitting the second control signal to the power distribution subsystem to close the second primary switch to form the power distribution power path to allow the power from the one or more battery packs of the energy storage subsystem to flow to the inverter subsystem and to the converter subsystem, and
generating, with the main vehicle control unit, a third control signal and transmitting the third control signal to the power distribution subsystem to close the secondary switch to form the secondary power path to provide power from the one or more battery packs to the refrigeration subsystem.

20. The method of claim 19, further comprising generating, with the main vehicle control unit, an inverter control signal to activate the inverter subsystem, wherein the one or more battery packs produces direct current (DC) power that passes along the power distribution power path to the inverter subsystem, and
converting, with the inverter subsystem, the DC power to alternating current (AC) power, and wherein the AC power passes along the secondary power path to the refrigeration subsystem.

21. The method of claim 20, wherein the DC power from the one or more battery packs is at a first DC power level, the method further comprising generating, with the main vehicle control unit, a converter control signal to activate the converter subsystem for stepping down the DC power from the first DC power level to a second lower DC power level.

22. The method of claim 21, further comprising monitoring, with the main vehicle control unit, one or more of the plurality of trailer subsystems for a selected power fault, and
if detected, initiating a power corrective action.

23. The method of claim 22, further comprising
generating the regenerative power with the electronic axle subsystem, and
if the regenerative power is detected by the main vehicle control unit, conveying the regenerative power to the refrigeration subsystem via at least the power distribution power path.
